(19) United States
(12) Patent Application Publication
(10) Pub. No.: US 2017/0164736 A1
(43) Pub. Date: Jun. 15, 2017

(54) REMOVABLE AND AUTOMATICALLY RE-LATCHING TRAY DEVICE AND METHOD

(71) Applicant: FIO Corporation, Toronto (CA)

(72) Inventor: Gilad Shoham, Toronto (CA)

(21) Appl. No.: 15/039,634

(22) PCT Filed: Nov. 26, 2014
(86) PCT No.: PCT/CA2014/000851

§ 371 Date: May 26, 2016

Related U.S. Application Data
(60) Provisional application No. 61/909,348, filed on Nov. 26, 2013.

(51) Int. Cl. A47B 88/40; E05B 65/46; E05C 3/14; A47B 88/919

(52) U.S. Cl. CPC A47B 88/40; A47B 88/919; E05B 65/46; E05C 3/14; G01N 35/00

(57) ABSTRACT

Closed, a tray is received within a housing aperture. The tray is preferably mounted to the housing by way of a sliding carriage assembly. Levers are mounted to the tray and pivotable between latching and releasing configurations. Latched, the levers prevent removal of the tray from (the carriage and) the housing. When the tray is opened and the levers are in the releasing configuration, the tray is selectively removable from (the carriage and) the housing. On selective re-engagement with (the carriage and) the housing and movement to the closed configuration, lever surfaces are urged by aligning surfaces on (the carriage or) the housing to automatically pivot the levers towards the latching configuration.

### FIELD OF THE INVENTION

The present disclosure relates generally to a tray device and method and, more particularly, to a removable and automatically re-latching tray device and method.

### BACKGROUND OF THE INVENTION

What may be needed is a removable and automatically re-latching tray device and/or method. Preferably, such device and/or method may be capable of use with housings and/or diagnostic test devices—such as, for example, the Deki Reader offered by Fio Corporation (of Toronto, Ontario).

It may be an object of one aspect of the present invention to provide a tray which is fully-extendable from a housing (preferably, for example, by way of a telescoping arrangement of components) and/or which enables a user to readily place one or more specimens for analysis by the device.

What may be needed is a tray which, during typical use, may be prevented from being removed from a device or housing.

It may be an object of one aspect of the present invention to provide a tray which may be readily and/or selectively removable from a housing and/or, when re-inserted, it may smoothly, gradually and/or automatically re-latch.

What may be needed is a device and/or method wherein re-insertion of a tray may not require it to be in any particular configuration in order to re-latch, and/or may be readily performed by users of varying skill and/or familiarity with the device and/or the tray.

It may be an object of one aspect of the present invention to provide a tray device and/or method which has interchangeable components and/or ones which may be affordably manufactured.

What may be needed is a tray which may be easily-removable from a housing or device and/or may preferably enable the device to employ interchangeable tray systems, e.g., to enable custom-branded trays and/or trays with various different functionalities.

It may be an object of one aspect of the present invention to provide a device and/or method which overcomes, traverses, obviates and/or mitigates one or more of limitations, disadvantages and/or shortcomings associated with the prior art, which helps to do so, which provides advantages and/or one of the aforementioned needs, and/or which achieves and/or helps to achieve one or more of the aforementioned objects of the invention.

### SUMMARY OF THE INVENTION

According to the invention, there is disclosed a removable and automatically re-latching tray and housing device. The tray and housing device includes a housing which is shaped to define a housing aperture. The device includes a tray which is selectively movable, relative to the housing, between a closed configuration and an opened configuration. In the closed configuration, the tray engages the housing and is received within the housing aperture. In the opened configuration, the tray extends outward from the housing aperture and engages the housing in selectively removable relation. First and second device portions are selected from the housing and the tray. The first device portion is different than the second device portion. The device includes at least one lever stopping surface and at least one lever aligning surface. The lever stopping surface and the lever aligning surface are presented by the first device portion. The device includes at least one lever. Each aforesaid lever includes an opening stop surface, a released lever alignment surface, and a pivot point which is pivotably mounted to the second device portion. The lever is selectively pivotable about the pivot point between a latching configuration and a releasing configuration. In the latching configuration, when the tray is in the opened configuration, the opening stop surface securely engages the lever stopping surface such as to prevent removal of the tray from the housing. In the releasing configuration, when the tray is in the opened configuration, the opening stop surface is clear of the lever stopping surface and the tray is selectively removable from the housing aperture and from the housing. After removal of the tray from the housing aperture and from the housing, the tray is selectively re-engageable with the housing. When the lever is in the releasing configuration upon selective re-engagement of the tray with the housing as aforesaid, the released lever alignment surface engages the lever aligning surface. When the lever is in the releasing configuration during movement of the tray from the opened configuration to the closed configuration, the released lever alignment surface engages and is urged by the lever aligning surface such that the lever is automatically pivoted about the pivot point towards the latching configuration.

According to an aspect of one preferred embodiment of the invention, the device may preferably, but need not necessarily, also include at least one latch stopping surface, preferably presented by the second device portion. Each aforesaid lever may preferably, but need not necessarily, also include a latch stop surface. Preferably, when the lever is pivoted about the pivot point into the latching configuration, and preferably during movement of the tray from the opened configuration to the closed configuration as aforesaid, the latch stopping surface may preferably, but need not necessarily, engage the latch stop surface, preferably to prevent further pivoting of the lever about the pivot point.

According to an aspect of one preferred embodiment of the invention, preferably after removal of the tray from the housing aperture and/or from the housing, the lever may preferably, but need not necessarily, be arbitrarily pivotable away from the releasing configuration, about the pivot point, preferably beyond the latching configuration and/or towards an askew configuration. Each aforesaid lever may preferably, but need not necessarily, also include an askew lever alignment surface. Preferably, when the lever is in the askew configuration upon selective re-engagement of the tray with the housing as aforesaid, the askew lever alignment surface may preferably, but need not necessarily, engage and be urged by the lever aligning surface such that the lever may preferably, but need not necessarily, be automatically pivoted about the pivot point, preferably towards the latching configuration.

According to an aspect of one preferred embodiment of the invention, the device may preferably, but need not necessarily, also include at least one détente, preferably mounted on the second device portion. The détente may preferably, but need not necessarily, bias the lever, preferably towards the latching configuration.

According to an aspect of one preferred embodiment of the invention, the device may preferably, but need not necessarily, also include at least one lever release stopping surface, preferably presented by the second device portion. Each aforesaid lever may preferably, but need not necessarily, also include a handle and/or a lever release stop surface. The handle may preferably, but need not necessarily, be selectively pivotable by hand about the pivot point from the latching configuration and/or into the releasing configuration. The lever release stopping surface may preferably, but need not necessarily, then engage the lever release stop surface, preferably to prevent further pivoting of the lever about the pivot point.

According to an aspect of one preferred embodiment of the invention, the first device portion may preferably be the housing, and/or the second device portion may preferably be the tray.

According to an aspect of one preferred embodiment of the invention, the housing may preferably, but need not necessarily, include a carriage which may preferably, but need not necessarily, be movable relative to the housing aperture. Preferably in the closed configuration, the tray may preferably, but need not necessarily, engage the carriage and/or the carriage may preferably, but need not necessarily, be received within the housing aperture. Preferably in the opened configuration, the tray may preferably, but need not necessarily, extend outward from the carriage and/or engage the carriage in selectively removable relation. Preferably in the latching configuration and/or when the tray is in the opened configuration, the tray may preferably, but need not necessarily, be prevented from being removed from the carriage.

According to an aspect of one preferred embodiment of the invention, the aforesaid at least one lever may preferably, but need not necessarily, include a first aforesaid lever and/or a second aforesaid lever. Preferably for each aforesaid lever, the device may preferably, but need not necessarily, include a respective one aforesaid lever stopping surface and/or a respective one aforesaid lever aligning surface.

According to an aspect of one preferred embodiment of the invention, the first aforesaid lever may preferably, but need not necessarily, be identical to the second aforesaid lever.

According to an aspect of one preferred embodiment of the invention, a first surface and/or a respective other surface may preferably, but need not necessarily, be selected from the released lever alignment surface and the lever aligning surface. The first surface may preferably, but need not necessarily, include a curved portion which may preferably, but need not necessarily, be so shaped such as to, preferably when the lever is in the releasing configuration and/or during movement of the tray from the opened configuration to the closed configuration, smoothly and/or gradually bear against the respective other surface, and/or smoothly and/or gradually pivot the lever about the pivot point preferably towards the latching configuration as aforesaid.

According to an aspect of one preferred embodiment of the invention, the first surface may preferably be the released lever alignment surface, and/or the respective other surface may preferably be the lever aligning surface.

According to the invention, there is also disclosed a removable and automatically re-latching tray and carriage device. The tray and carriage device is for use with a housing which is shaped to define a housing aperture. The device includes a carriage which engages the housing. The device includes a tray which is selectively movable relative to the carriage. The carriage and the tray are selectively movable, relative to the housing and the housing aperture, between a closed configuration and an opened configuration. In the closed configuration, the tray engages the carriage and the carriage is received within the housing aperture. In the opened configuration, the tray extends outward from the carriage and the housing aperture and engages the carriage in selectively removable relation. First and second device portions are selected from the carriage and the tray. The first device portion is different than the second device portion. The device includes at least one lever stopping surface and at least one lever aligning surface. The lever stopping surface and the lever aligning surface are presented by the first device portion. The device includes at least one lever. Each aforesaid lever includes an opening stop surface, a released lever alignment surface, and a pivot point which is pivotably mounted to the second device portion. The lever is selectively pivotable about the pivot point between a latching configuration and a releasing configuration. In the latching configuration, when the tray is in the opened configuration, the opening stop surface securely engages the lever stopping surface such as to prevent removal of the tray from the carriage. In the releasing configuration, when the tray is in the opened configuration, the opening stop surface is clear of the lever stopping surface and the tray is selectively removable from the carriage. After removal of the tray from the carriage, the tray is selectively re-engageable with the carriage. When the lever is in the releasing configuration upon selective re-engagement of the tray with the carriage as aforesaid, the released lever alignment surface engages the lever aligning surface. When the lever is in the releasing configuration during movement of the tray from the opened configuration to the closed configuration, the released lever alignment surface engages and is urged by the lever aligning surface such that the lever is automatically pivoted about the pivot point towards the latching configuration.

According to the invention, there is also disclosed a method of removably mounting an automatically re-latching tray on a housing which is shaped to define a housing aperture. The method includes a step (a) of mounting the tray on the housing, such that the tray is selectively movable, relative to the housing, between a closed configuration and an opened configuration. In the closed configuration, the tray is received within the housing aperture. In the opened configuration, the tray extends outward from the housing aperture and engages the housing in selectively removable relation. According to the method, first and second device portions are selected from the housing and the tray. The first device portion is different than the second device portion. The method includes a step (b) of providing at least one lever stopping surface and at least one lever aligning surface on the first device portion. The method includes a step (c) of providing at least one lever. Each aforesaid lever includes an opening stop surface, a released lever alignment surface, and a pivot point which is pivotably mounted to the second device portion. The lever is selectively pivotable about the pivot point between a latching configuration and a releasing configuration. In the latching configuration, when the tray is in the opened configuration, the opening stop surface securely engages the lever stopping surface such as to prevent removal of the tray from the housing. In the releasing configuration, when the tray is in the opened configuration, the opening stop surface is clear of the lever stopping surface and the tray is selectively removable from the housing aperture and from the housing. Aforesaid steps (a), (b) and (c) are such that, after removal of the tray from the housing aperture and from the housing, the tray is selectively re-engageable with the housing and, when the lever is in the releasing configuration upon selective re-engagement of the tray with the housing as aforesaid, the released lever alignment surface engages the lever aligning surface. Aforesaid steps (a), (b) and (c) are such that, when the lever is in the releasing configuration during movement of the tray from the opened configuration to the closed configuration, the released lever alignment surface engages and is urged by the lever aligning surface such that the lever is automatically pivoted about the pivot point towards the latching configuration.

According to the invention, there is also disclosed a method of removably mounting an automatically re-latching tray and a carriage on a housing which is shaped to define a housing aperture. The method includes step (a) of mounting the carriage on the housing and mounting the tray on the carriage, such that the tray is selectively movable relative to the carriage, and such that the carriage and the tray are selectively movable, relative to the housing and the housing aperture, between a closed configuration and an opened configuration. In the closed configuration, the tray engages the carriage and the carriage is received within the housing aperture. In the opened configuration, the tray extends outward from the carriage and the housing aperture and engages the carriage in selectively removable relation. According to the method, first and second device portions are selected from the carriage and the tray. The first device portion is different than the second device portion. The method includes step (b) of providing at least one lever stopping surface and at least one lever aligning surface on the first device portion. The method includes step (c) of providing at least one lever. Each aforesaid lever includes an opening stop surface, a released lever alignment surface, and a pivot point which is pivotably mounted to the second device portion. The lever is selectively pivotable about the pivot point between a latching configuration and a releasing configuration. In the latching configuration, when the tray is in the opened configuration, the opening stop surface securely engages the lever stopping surface such as to prevent removal of the tray from the carriage. In the releasing configuration, when the tray is in the opened configuration, the opening stop surface is clear of the lever stopping surface and the tray is selectively removable from the carriage. Aforesaid steps (a), (b) and (c) are such that, after removal of the tray from the carriage, the tray is selectively re-engageable with the carriage and, when the lever is in the releasing configuration upon selective re-engagement of the tray with the carriage as aforesaid, the released lever alignment surface engages the lever aligning surface. Aforesaid steps (a), (b) and (c) are such that, when the lever is in the releasing configuration during movement of the tray from the opened configuration to the closed configuration, the released lever alignment surface engages and is urged by the lever aligning surface such that the lever is automatically pivoted about the pivot point towards the latching configuration.

Other advantages, features and/or characteristics of the present invention, as well as methods of operation and/or functions of the related elements of the device and method, and/or the combination of steps, parts and/or economies of manufacture, will become more apparent upon consideration of the following detailed description and the appended claims with reference to the accompanying drawings, the latter of which are briefly described hereinbelow.

### BRIEF DESCRIPTION OF THE DRAWINGS

The novel features which are believed to be characteristic of the device and method according to the present invention, as to their structure, organization, use, and/or method of operation, together with further objectives and/or advantages thereof, will be better understood from the following drawings in which presently preferred embodiments of the invention will now be illustrated by way of example. It is expressly understood, however, that the drawings are for the purpose of illustration and description only, and are not intended as a definition of the limits of the invention. In the accompanying drawings:

FIG. 1 is a top front left perspective view of a removable and automatically re-latching tray and carriage device according to one preferred embodiment of the invention shown, in use with a housing, in a closed configuration;

FIG. 2 is a top front left perspective view of the device of FIG. 1, shown in an opened configuration;

FIG. 3 is a view similar to FIG. 2, showing the device of FIG. 1 without the housing;

FIG. 4 is a bottom view of the device of FIG. 1 shown, without the housing and with a carriage of the device in wireframe outline, in a closed latching configuration;

FIG. 5 is a view similar to FIG. 4, showing the device of FIG. 1 in an opened latching configuration;

FIG. 6 is a view similar to FIG. 5, showing the device of FIG. 1 in an opened releasing configuration;

FIG. 7 is a view similar to FIG. 6, showing the device of FIG. 1 during movement toward the closed configuration;

FIG. 8 is a cross-sectional view of the device along line 8-8 of FIG. 6;

FIG. 9 is a cross-sectional view of the device along line 9-9 of FIG. 5;

FIG. 10 is a bottom view of levers and, in cross-section, a carriage of a device according to one preferred embodiment of the invention shown, without a housing and after removal therefrom, in an askew configuration;

FIG. 11 is a view similar to FIG. 10, showing the carriage and levers thereof during re-engagement;

FIG. 12 is a view similar to FIG. 10, showing the carriage and levers thereof in the closed latching configuration;

FIG. 13 is a view similar to FIG. 10, showing the carriage and levers thereof in the opened latching configuration;

FIG. 14 is a view similar to FIG. 13, showing the carriage and levers thereof in the opened releasing configuration;

FIG. 15 is a top front left perspective view of a removable and automatically re-latching tray and housing device according to one preferred embodiment of the invention, shown in an opened configuration with a housing thereof shown in phantom outline;

FIG. 16A is two bottom views of the device of FIG. 15, shown without the housing and with a carriage thereof alternately in wireframe outline with a tray of the device, and with part of the tray and levers in cross-section, in the closed latching configuration;

FIG. 16B is two bottom views similar to FIG. 16A, showing the device of FIG. 15 in the opened latching configuration;

FIG. 16C is two bottom views similar to FIG. 16A, showing the device of FIG. 15 in the opened releasing configuration;

FIG. 17A is a bottom view of the carriage (in cross section) and levers of the device of FIG. 15 shown, without the housing, in the opened releasing configuration; and

FIG. 17B is a view similar to FIG. 17A, showing the device of FIG. 15 in the closed latching configuration.

### DETAILED DESCRIPTION OF PREFERRED EMBODIMENTS

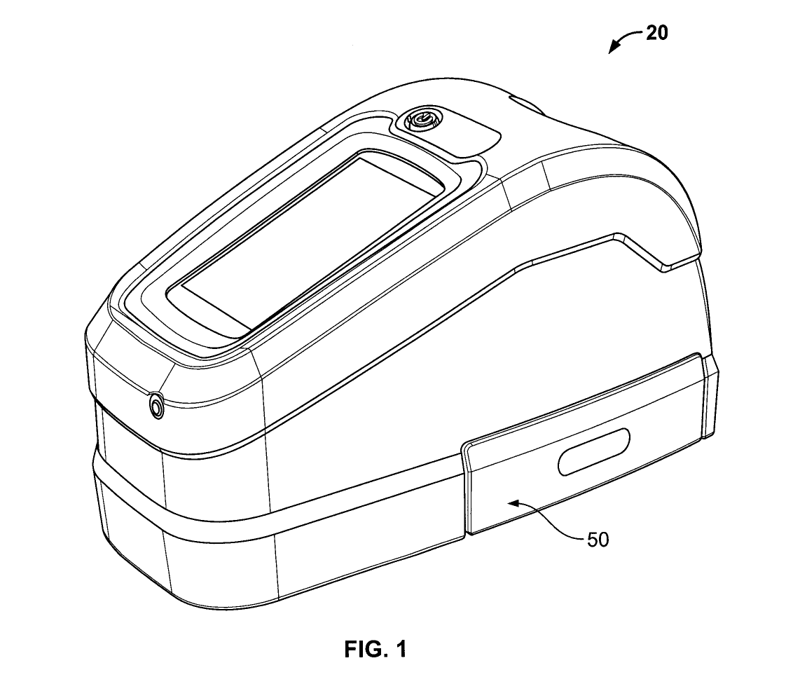

According to the invention, and as shown in FIG. 1, a diagnostic test device or housing 20—for example, the Deki Reader offered by Fio Corporation (of Toronto, Ontario)—may preferably be provided with a full-extension specimen tray 50, similar to a drawer, upon which a user may preferably place one or more specimens (not shown) to be analyzed by the device.

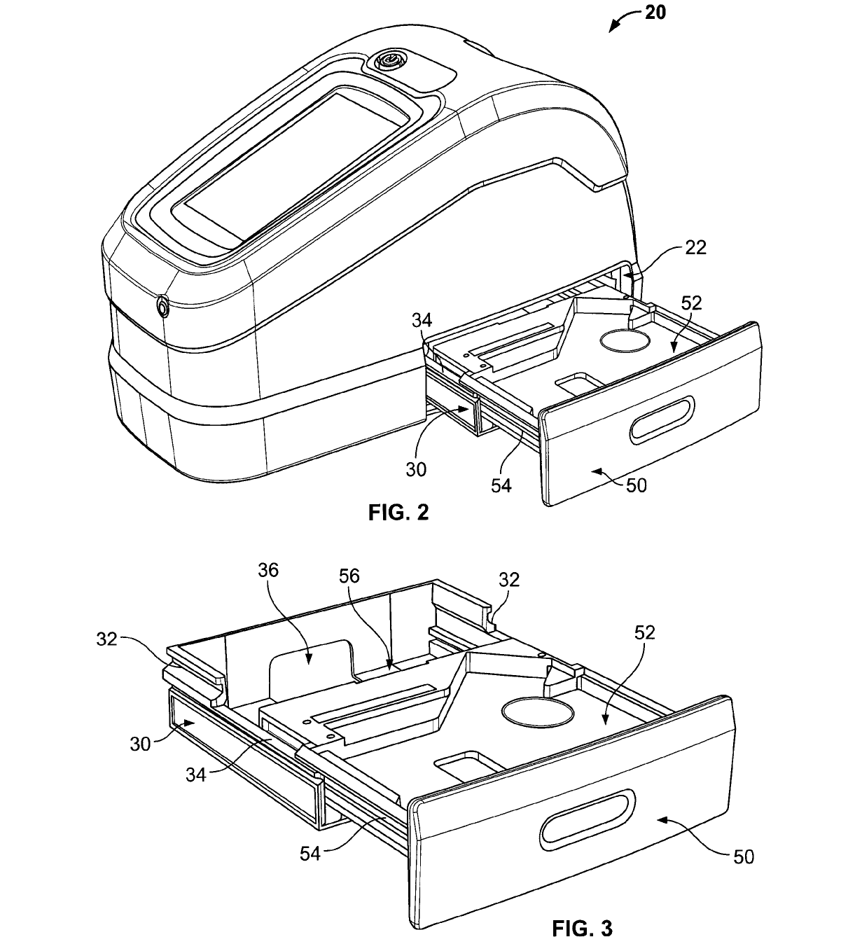

As shown in FIGS. 2 and 15, the tray 50 is preferably slidably received within an aperture 22 in the housing 20. As shown in FIGS. 2 and 3, the tray 50 is preferably provided with a specimen receiving portion 52.

According to the invention, the tray 50 may be preferably provided with a ‘full extension’ mechanism which may preferably work by way of a telescoping arrangement of components.

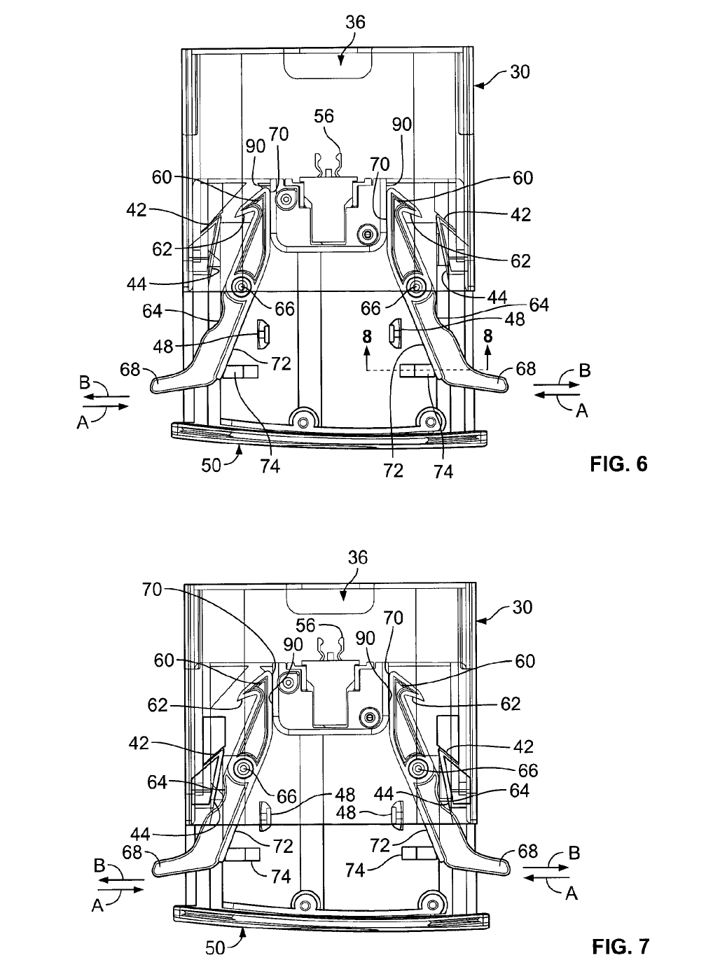

According to the invention, the specimen tray 50 may be preferably carried within a sliding carriage 30. As shown in FIGS. 2 and 3, the carriage 30 preferably has two device rails 32 to slidably engage corresponding rails (not shown) on the device 20, and preferably two tray rails 34 to slidably engage one or more carriage rails 54 provided on the tray 50. The tray 50 is preferably provided with a mechanism 56 (see FIGS. 5 and 6) which, in a closed configuration, extends through an opening 36 in the carriage 30 to engage a latch (not shown) inside the aperture 22 of the device 20 to releasably retain the tray 50 and carriage 30 in the closed configuration.

According to the invention, the sliding carriage 30 may preferably be able to slide forward and/or backward within the device 20—e.g., about forty millimeters (40 mm). The specimen tray 50 may preferably also slide within the sliding carriage 50—e.g., also about 40 mm—for a combined total (telescopic) tray 50 movement—e.g., of about eighty (80) mm.

Tray Removability

According to the invention, during typical use, the specimen tray 50 may preferably be prevented from being removed from the housing 20, preferably with the aid of two levers 60. Each lever 60 may preferably have an opening stop surface 62 which may preferably engage with a respective lever stopping surface 42 on the sliding carriage 30 to ordinarily prevent the tray 50 from being removed from carriage 30 and housing 20.

In the figures, a bottom of the carriage 30 and drawer 50 may be shown. Some figures may show certain features of the invention and its cooperating environment in wireframe, partial and/or full phantom, transparent and/or sectional views. The carriage 30 and drawer 50 are shown in a closed configuration and in an opened configuration with the levers (or “latches”) 60 in the releasing configuration.

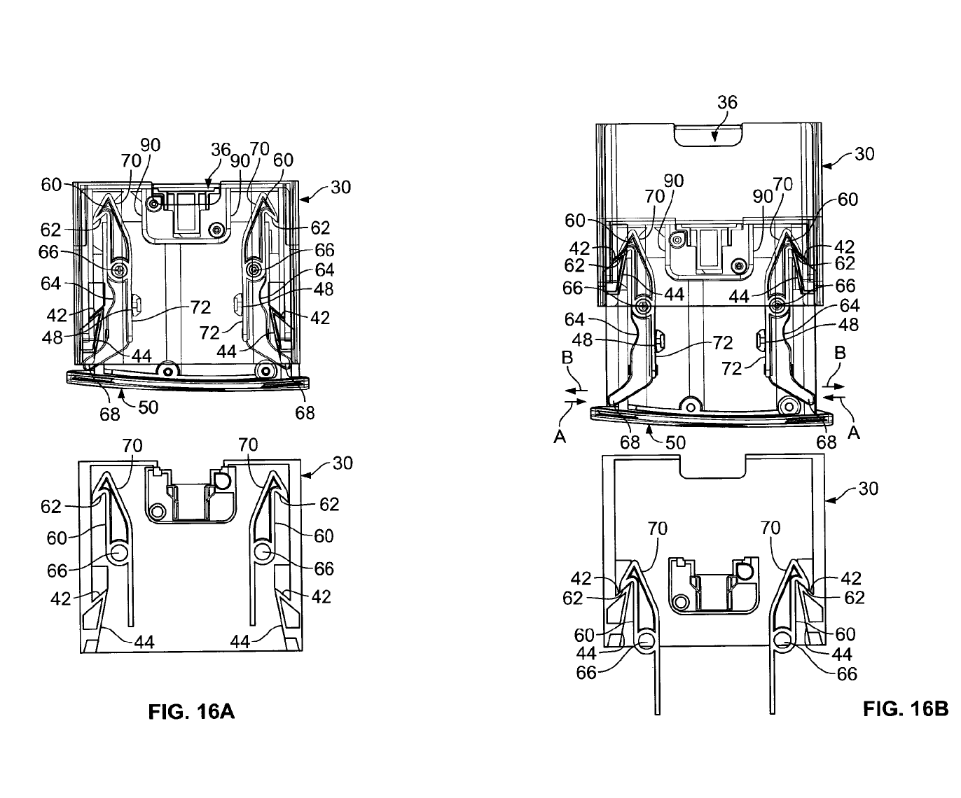

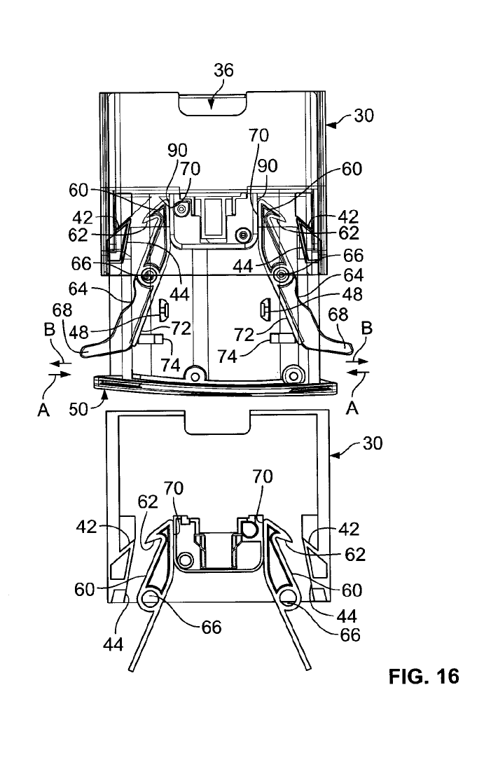

With the tray 50 in an opened configuration, as shown in FIG. 5, handles 68 of the levers 60 may be pivoted, each about a pivot point 66, in an outward direction as indicated generally by arrows “B”. As shown in FIG. 6, a lever release stop surface 70 of each lever 60 may preferably engage a lever release stopping surface 90 of the tray 50 when each lever 60 is in a fully released configuration. FIGS. 16A to 16C show, in sequence, movement between the closed latching configuration, the opened latching configuration, and the opened releasing configuration. With the levers 60 so configured, the tray 50 may be removed from the carriage 30.

Automatic Re-Latching Upon Tray Insertion

Preferably when the tray 50 may be re-inserted, lever aligning surfaces 44 of the sliding carriage 30 may preferably make contact with a released lever alignment surface 64 provided on each of the latch levers 60, preferably causing them to straighten. Preferably, an initially engaging portion of the released lever alignment surface 64 may preferably be shaped into a curved (or otherwise shaped) surface which may preferably cause the levers 60 to straighten gradually and/or less abruptly than would initial contact with a flat surface. [Alternately or in addition (not shown), an initially engaging portion of the lever aligning surface 44 may preferably be so shaped.]

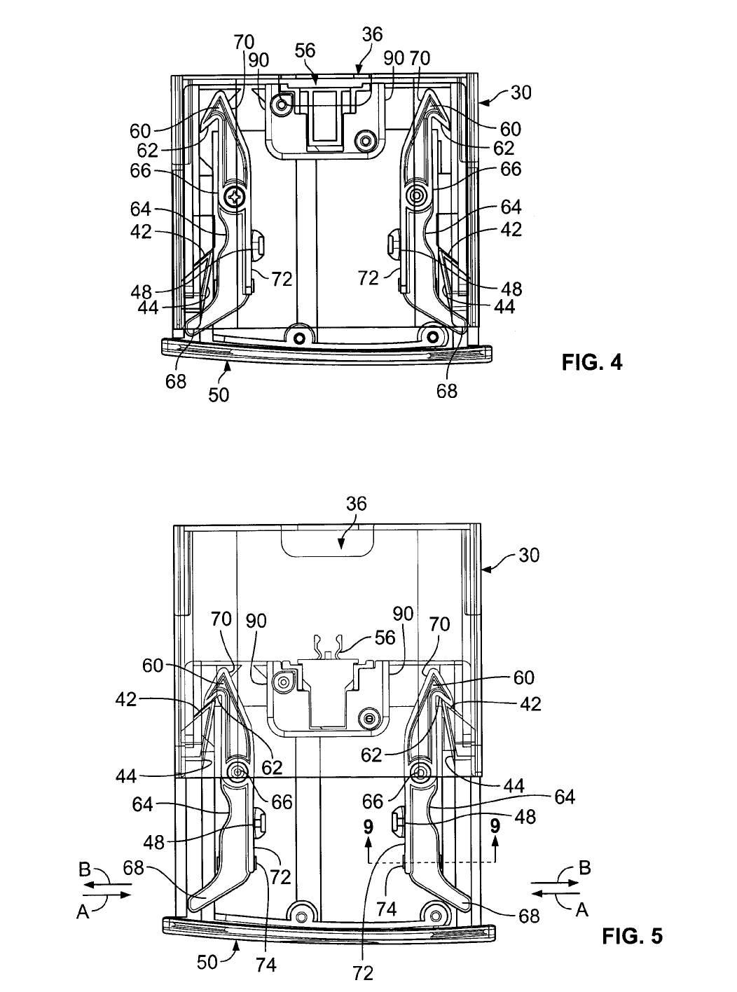

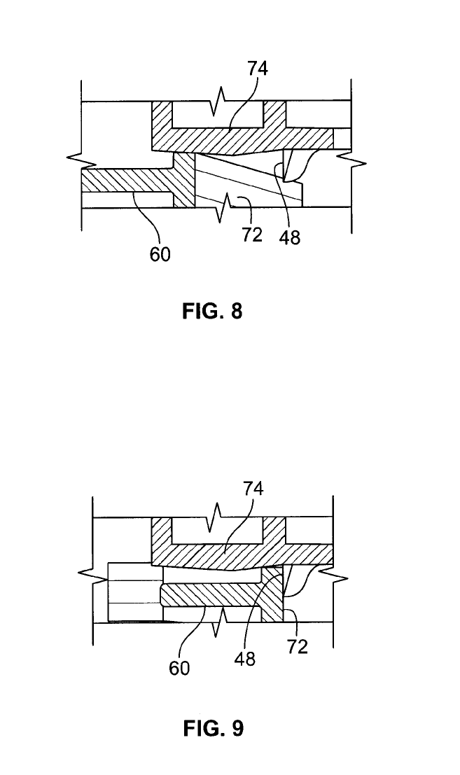

During re-insertion, a handle 68 of each lever 60 may be pivoted, about its pivot point 66, in an inward direction as generally indicated by arrows “A”. In so pivoting, each lever 60 may be urged past a détente 74 (see FIGS. 7-9) which is preferably provided on the tray 50, preferably so as to bias the lever 60 towards a locking configuration as shown in FIGS. 4, 5 and 9, among others. In the locking configuration, a latch stop surface 72 of each lever 60 may preferably engage a latch stopping surface 48 provided on the tray 50, preferably when each lever 60 is in a fully locking configuration.

The auto-relatching may preferably ensure that the next time the tray 50 is extended, the levers 60 once again catch on the sliding carriage 30 lever stopping surfaces (or “catch-points”) 42.

According to the invention, the levers 60 of the specimen tray 50 might be moved towards the ‘releasing’ configuration manually, mechanically, selectively and/or automatically. In the embodiments shown in the figures, the handles 68 might be selectively moved to manually position the levers 60 into the releasing configuration, but it is within the scope of the invention for this feature to be supplemented and/or replaced by the inclusion of an additional and/or alternate mechanism to automatically move the levers 60 into this position if/as desired—e.g., at the end of one or more specimen workflows and/or when a button (not shown) is pressed on the device 20.

Similarly, persons skilled in the art should appreciated, in view of the disclosures herein, that it is within the scope of the invention for levers 60 of the specimen tray 50 to be moved towards the ‘latching’ configuration manually, mechanically, selectively and/or automatically.

When the tray 50 is removed from the reader device 20, as shown in some of the figures, handles 68 of the levers 60 may be arbitrarily pivoted, about the pivot points 66, inwards (in the general direction of arrow “A”) or outwards (in the general direction of arrow “B”) by a user.

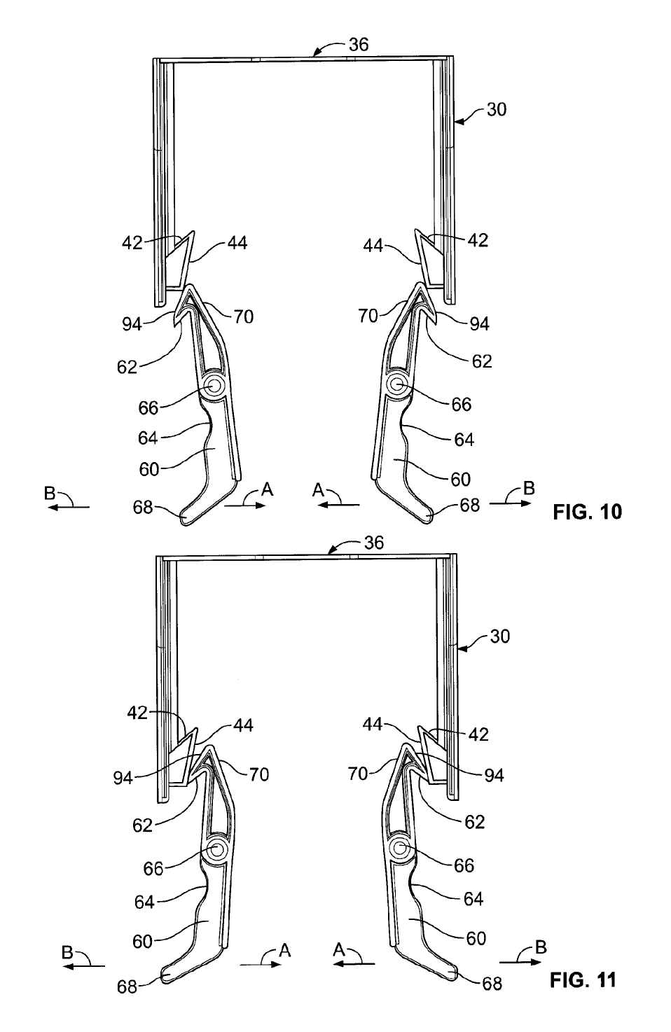

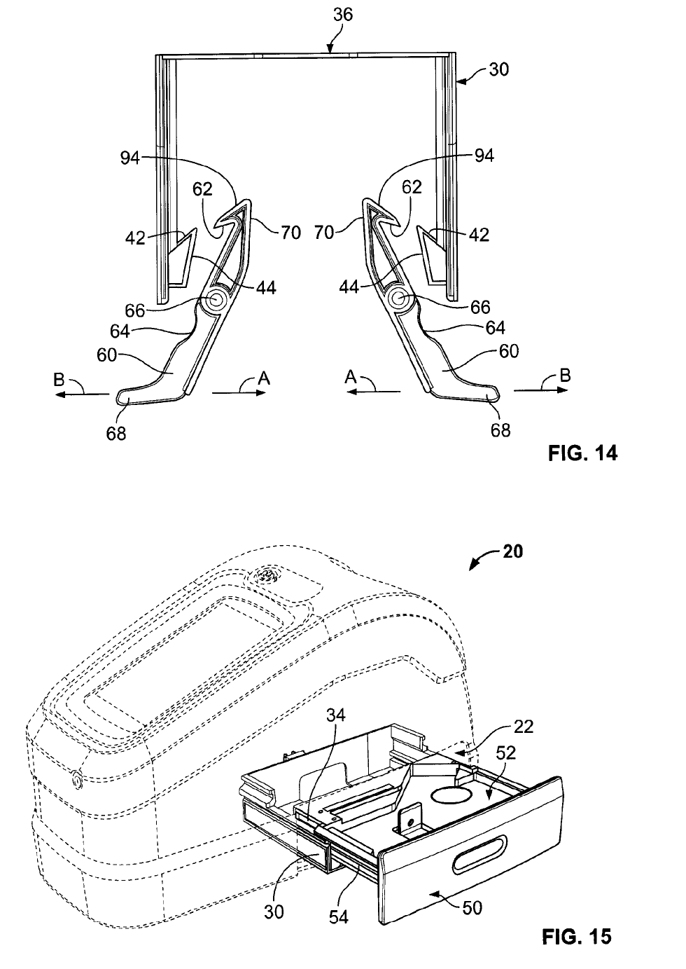

After removal of the tray 50 from the housing aperture 22 and from the housing 20, the levers 60 are arbitrarily pivotable away from the releasing configuration (shown in FIG. 14), about the pivot points 66, beyond the latching configuration (shown in FIG. 13) towards an askew configuration (shown in FIGS. 10 and 11). Each of the levers 60 also includes an askew lever alignment surface 94. As shown in FIGS. 10 and 11, when either or both of the levers 60 is in the askew configuration upon selective re-engagement of the tray 50 with the housing 20 and the carriage 30, the askew lever alignment surface 94 of the lever 60 engages and is urged by the lever aligning surface 44 such that the lever 60 is automatically pivoted about the pivot point towards the latching configuration.

That is, according to one preferred embodiment of the invention, and as shown in various figures, the tray 50 may preferably accommodate automatic lever 60 re-engagement when the tray 50 is reinserted. That is, the levers 60 may preferably toggle between one or more of the latching, releasing and askew configurations. Preferably regardless of how the levers 60 are positioned (individually or as a pair) and/or preferably upon reinsertion of the tray into the sliding carriage 30, the levers 60 may preferably be oriented—in sequence—into their releasing or askew configurations and then into their latching configuration. The levers 60 may preferably stay in the latching configuration after tray 50 insertion. This configuration is that which they may preferably be in for standard device 20 operation.

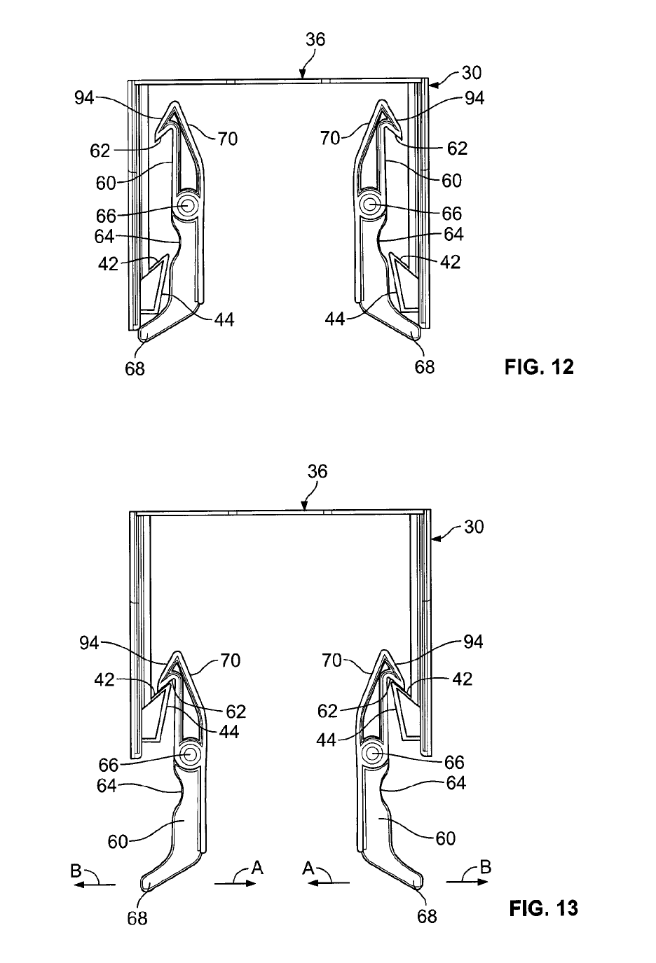

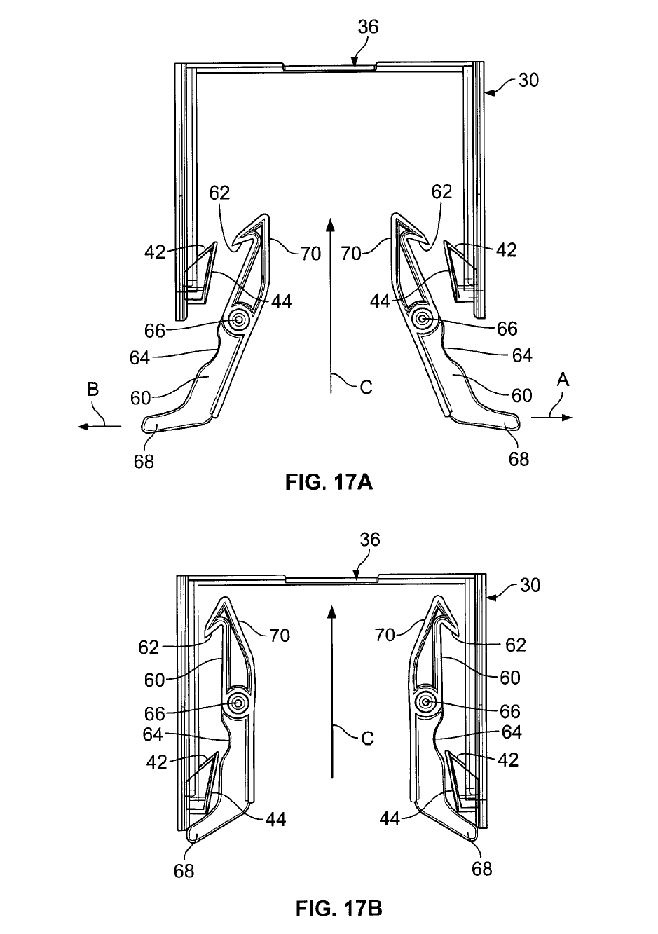

FIG. 7 shows the tray 50 during movement toward the closed configuration, with the levers 60 engaging the carriage 30. FIGS. 17A and 17B also show the levers 60 during movement, in a closing direction (indicated generally by arrow “C”), from the opened releasing configuration towards the closed latching configuration. Similarly, FIG. 12 shows the carriage 30 and levers 60 in the closed latching configuration.

Economies of Manufacture and Assembly

Advantageously, the two levers 60 shown in the figures may preferably be the same part (i.e., identical non-mirror images), used on left and right sides of the tray 50. Though one preferred embodiment contemplates that they are the same part, as aforesaid and as shown in the figures, other envisioned uses are also within the scope of the invention—e.g., mirrored latch lever 60 parts, dissimilar latch lever 60 parts, or even using other-than-two levers 60 in an assembly (for instance, using only one lever 60).

The easily-removable tray 50 which is provided according to the present invention may preferably enable the device or housing 20 to employ an interchangeable tray 50 system, where the tray 50 of the device or housing 20 may preferably be readily changed to a different tray 50 (including, but not limited to, custom-branded trays 50, or trays 50 with different functionality, such as fluorescent-capable trays 50).

Method

In a preferred method according to the invention, the tray 50 is mounted on the carriage 30 which is mounted on the housing 20, such that the tray 50 is selectively movable relative to the carriage 30 and the carriage 30 and tray 50 are selectively movable, relative to the housing 20 and the housing aperture 22, between the closed and opened configurations. As aforesaid, in the closed configuration, the tray 50 engages the carriage 30 and the carriage 30 is received within the housing aperture 22 and, in the opened configuration, the tray 50 extends outward from the carriage 30 and housing aperture 22 and engages the carriage 30 in selectively removable relation.

According to the method, two lever stopping surfaces 48 and two lever aligning surfaces 44 are preferably provided on the carriage 30.

According to the method, two levers 60 are also preferably provided, each including its opening stop surface 62, released lever alignment surface 64, and pivot point 66 pivotably mounted to tray 50. Each lever 60 is selectively pivotable about the pivot point 66 between the latching and releasing configurations. In the latching configuration, when the tray 50 is in the opened configuration, the opening stop surfaces 62 securely engage the lever stopping surfaces 48 such as to prevent removal of the tray 50 from the carriage 30. In the releasing configuration, when the tray 50 is in the opened configuration, the opening stop surfaces 62 are clear of the lever stopping surfaces 42 and the tray 50 is selectively removable from the carriage 30.

The method is preferably such that, after removal of the tray 50 from the carriage 30, the tray 50 is selectively re-engageable with the carriage 30 and, when the levers 60 are in the releasing configuration upon selective re-engagement of the tray 50 with the carriage 30 as aforesaid, the released lever alignment surfaces 64 engage the lever aligning surfaces 44.

The method is also preferably such that, when the levers 60 are in the releasing configuration during movement of the tray 50 from the opened configuration to the closed configuration, the released lever alignment surfaces 64 engage and are urged by the lever aligning surfaces 44 such that the levers 60 are automatically pivoted about their pivot points 66 towards the latching configuration.

### Other Embodiments

The invention is contemplated for use in diagnostic test settings around the world, in association with diagnostic test devices, to afford increased functionality and/or advantageous utilities in association with same. The invention, however, is not so limited and use with other devices and housings is contemplated.

The foregoing description has been presented for the purpose of illustration and is not intended to be exhaustive or to limit the invention to the precise form disclosed.

Naturally, in view of the teachings and disclosures herein, persons having ordinary skill in the art may appreciate that alternate designs and/or embodiments of the invention may be possible (e.g., with substitution of one or more components for others, with alternate configurations of components, etc.). Although some of the components, relations, configurations and/or steps according to the invention are not specifically referenced in association with one another, they may be used, and/or adapted for use, in association therewith. All of the aforementioned, depicted and various structures, configurations, relationships, utilities and the like may be, but are not necessarily, incorporated into and/or achieved by the invention. Any one or more of the aforementioned structures, configurations, relationships, utilities and the like may be implemented in and/or by the invention, on their own, and/or without reference, regard or likewise implementation of any of the other aforementioned structures, configurations, relationships, utilities and the like, in various permutations and combinations, as will be readily apparent to those skilled in the art, without departing from the pith, marrow, and spirit of the disclosed invention.

Other modifications and alterations may be used in the design, manufacture, and/or implementation of other embodiments according to the present invention without departing from the spirit and scope of the invention, which is limited only by the claims hereof.

1. A removable and automatically re-latching tray and housing device comprising:
(a) a housing shaped to define a housing aperture;
(b) a tray which is selectively movable, relative to the housing, between: (i) a closed configuration wherein the tray engages the housing and is received within the housing aperture; and (ii) an opened configuration wherein the tray extends outward from the housing aperture and engages the housing in selectively removable relation;
at least one lever stopping surface and at least one lever aligning surface; wherein a first device portion and a second device portion are selected from the housing and the tray, such that the first device portion is different than the second device portion; wherein the lever stopping surface and the lever aligning surface are presented by the first device portion;
(c) at least one lever, each said lever comprising an opening stop surface, a released lever alignment surface, and a pivot point which is pivotably mounted to the second device portion; wherein the lever is selectively pivotable about the pivot point between: (i) a latching configuration wherein, when the tray is in the opened configuration, the opening stop surface securely engages the lever stopping surface such as to prevent removal of the tray from the housing; and (ii) a releasing configuration wherein, when the tray is in the opened configuration, the opening stop surface is clear of the lever stopping surface and the tray is selectively removable from the housing aperture and from the housing;
wherein, after removal of the tray from the housing aperture and from the housing, the tray is selectively re-engageable with the housing and, when the lever is in the releasing configuration upon selective re-engagement of the tray with the housing as aforesaid, the released lever alignment surface engages the lever aligning surface; and
wherein when the lever is in the releasing configuration during movement of the tray from the opened configuration to the closed configuration, the released lever alignment surface engages and is urged by the lever aligning surface such that the lever is automatically pivoted about the pivot point towards the latching configuration.

2. A device according to claim 1, further comprising at least one latch stopping surface presented by the second device portion; wherein each said lever further comprises a latch stop surface; and wherein when the lever is pivoted about the pivot point into the latching configuration, during movement of the tray from the opened configuration to the closed configuration as aforesaid, the latch stopping surface engages the latch stop surface to prevent further pivoting of the lever about the pivot point.

3. A device according to claim 1 wherein, after removal of the tray from the housing aperture and from the housing, the lever is arbitrarily pivotable away from the releasing configuration, about the pivot point, beyond the latching configuration towards an askew configuration; wherein each said lever further comprises an askew lever alignment surface; wherein, when the lever is in the askew configuration upon selective re-engagement of the tray with the housing as aforesaid, the askew lever alignment surface engages and is urged by the lever aligning surface such that the lever is automatically pivoted about the pivot point towards the latching configuration.

4. A device according to claim 1, further comprising at least one détente mounted on the second device portion, with the détente biasing the lever towards the latching configuration.

5. A device according to claim 1, further comprising at least one lever release stopping surface presented by the second device portion; wherein each said lever further comprises a handle and a lever release stop surface; and wherein the handle is selectively pivotable by hand about the pivot point from the latching configuration into the releasing configuration, with the lever release stopping surface then engaging the lever release stop surface to prevent further pivoting of the lever about the pivot point.

6. A device according to claim 1, wherein the first device portion is the housing, and the second device portion is the tray.

7. A device according to claim 1, wherein the housing comprises a carriage which is movable relative to the housing aperture; wherein in the closed configuration the tray engages the carriage and the carriage is received within the housing aperture, and in the opened configuration the tray extends outward from the carriage and engages the carriage in selectively removable relation; and wherein in the latching configuration, when the tray is in the opened configuration, the tray is prevented from being removed from the carriage.

8. A device according to claim 1, wherein said at least one lever comprises a first said lever and a second said lever and wherein, for each said lever, the device comprises a respective one said lever stopping surface and a respective one said lever aligning surface.

9. A device according to claim 8, wherein the first said lever is identical to the second said lever.

10. A device according to claim 1, wherein a first surface and a respective other surface are selected from the released lever alignment surface and the lever aligning surface; and wherein the first surface comprises a curved portion which is so shaped such as to, when the lever is in the releasing configuration during movement of the tray from the opened configuration to the closed configuration, smoothly and gradually: (a) bear against the respective other surface; and (b) pivot the lever about the pivot point towards the latching configuration as aforesaid.

11. A device according to claim 10, wherein the first surface is the released lever alignment surface, and the respective other surface is the lever aligning surface.

12. A removable and automatically re-latching tray and carriage device, for use with a housing which is shaped to define a housing aperture, the device comprising:
(d) a carriage which engages the housing;
(e) a tray which is selectively movable, relative to the carriage;
wherein the carriage and the tray are selectively movable, relative to the housing and the housing aperture, between: (i) a closed configuration wherein the tray engages the carriage and the carriage is received within the housing aperture; and (ii) an opened configuration wherein the tray extends outward from the carriage and the housing aperture and engages the carriage in selectively removable relation;
(f) at least one lever stopping surface and at least one lever aligning surface; wherein a first device portion and a second device portion are selected from the carriage and the tray, such that the first device portion is different than the second device portion; wherein the lever stopping surface and the lever aligning surface are presented by the first device portion;
(g) at least one lever, each said lever comprising an opening stop surface, a released lever alignment surface, and a pivot point which is pivotably mounted to the second device portion; wherein the lever is selectively pivotable about the pivot point between: (i) a latching configuration wherein, when the tray is in the opened configuration, the opening stop surface securely engages the lever stopping surface such as to prevent removal of the tray from the carriage; and (ii) a releasing configuration wherein, when the tray is in the opened configuration, the opening stop surface is clear of the lever stopping surface and the tray is selectively removable from the carriage;
wherein, after removal of the tray from the carriage, the tray is selectively re-engageable with the carriage and, when the lever is in the releasing configuration upon selective re-engagement of the tray with the carriage as aforesaid, the released lever alignment surface engages the lever aligning surface; and
wherein when the lever is in the releasing configuration during movement of the tray from the opened configuration to the closed configuration, the released lever alignment surface engages and is urged by the lever aligning surface such that the lever is automatically pivoted about the pivot point towards the latching configuration.

13. A method of removably mounting an automatically re-latching tray on a housing which is shaped to define a housing aperture, the method comprising the steps of:
(h) mounting the tray on the housing, such that the tray is selectively movable, relative to the housing, between: (i) a closed configuration wherein the tray is received within the housing aperture; and (ii) an opened configuration wherein the tray extends outward from the housing aperture and engages the housing in selectively removable relation;
(i) providing at least one lever stopping surface and at least one lever aligning surface on a first device portion; wherein the first device portion and a second device portion are selected from the housing and the tray, such that the first device portion is different than the second device portion;
(j) providing at least one lever, each said lever comprising an opening stop surface, a released lever alignment surface, and a pivot point which is pivotably mounted to the second device portion; wherein the lever is selectively pivotable about the pivot point between: (i) a latching configuration wherein, when the tray is in the opened configuration, the opening stop surface securely engages the lever stopping surface such as to prevent removal of the tray from the housing; and (ii) a releasing configuration wherein, when the tray is in the opened configuration, the opening stop surface is clear of the lever stopping surface and the tray is selectively removable from the housing aperture and from the housing; and
wherein said steps (a), (b) and (c) are such that:
after removal of the tray from the housing aperture and from the housing, the tray is selectively re-engageable with the housing and, when the lever is in the releasing configuration upon selective re-engagement of the tray with the housing as aforesaid, the released lever alignment surface engages the lever aligning surface; and
when the lever is in the releasing configuration during movement of the tray from the opened configuration to the closed configuration, the released lever alignment surface engages and is urged by the lever aligning surface such that the lever is automatically pivoted about the pivot point towards the latching configuration.

14. A method of removably mounting an automatically re-latching tray and a carriage on a housing which is shaped to define a housing aperture, the method comprising the steps of:
(k) mounting the carriage on the housing and mounting the tray on the carriage, such that the tray is selectively movable relative to the carriage, and such that the carriage and the tray are selectively movable, relative to the housing and the housing aperture, between: (i) a closed configuration wherein the tray engages the carriage and the carriage is received within the housing aperture; and (ii) an opened configuration wherein the tray extends outward from the carriage and the housing aperture and engages the carriage in selectively removable relation;
(l) providing at least one lever stopping surface and at least one lever aligning surface on a first device portion; wherein the first device portion and a second device portion are selected from the carriage and the tray, such that the first device portion is different than the second device portion;
(m) providing at least one lever, each said lever comprising an opening stop surface, a released lever alignment surface, and a pivot point which is pivotably mounted to the second device portion; wherein the lever is selectively pivotable about the pivot point between: (i) a latching configuration wherein, when the tray is in the opened configuration, the opening stop surface securely engages the lever stopping surface such as to prevent removal of the tray from the carriage; and (ii) a releasing configuration wherein, when the tray is in the opened configuration, the opening stop surface is clear of the lever stopping surface and the tray is selectively removable from the carriage; and
wherein said steps (a), (b) and (c) are such that:
after removal of the tray from the carriage, the tray is selectively re-engageable with the carriage and, when the lever is in the releasing configuration upon selective re-engagement of the tray with the carriage as aforesaid, the released lever alignment surface engages the lever aligning surface; and
when the lever is in the releasing configuration during movement of the tray from the opened configuration to the closed configuration, the released lever alignment surface engages and is urged by the lever aligning surface such that the lever is automatically pivoted about the pivot point towards the latching configuration.
